(19) United States
(12) Patent Application Publication
(10) Pub. No.: US 2018/0068572 A1
(43) Pub. Date: Mar. 8, 2018

(54) Nucleus-Structure Chemistry Set

(71) Applicant: Eric Arno Vigen, Calabasas, CA (US)

(72) Inventor: Eric Arno Vigen, Calabasas, CA (US)

(21) Appl. No.: 15/256,865

(22) Filed: Sep. 6, 2016

(51) Int. Cl. G09B 1/38; G09B 23/24; G09B 23/18

(52) U.S. Cl. CPC G09B 1/38; G09B 23/181; G09B 23/24

(57) ABSTRACT

A three-dimensional instructional manipulative, model or display, including base units, with differentiation by methods including shape, color, size or markings, representing nucleus particles such as protons and neutrons, where each particle utilizes connections so that protons are separated by at least one neutron resulting in a structure that is chain, chain-ring, multiple-layer rings or combinations of those elements together with an indicator, based upon the nucleus as a set, of magnetic orientation, magnetic field shape, magnetic strength; and a further claim with options where those base unit connections operated via magnetics; and further claim adding at least one of the following: a spindle or platform for placement of the nucleus within orientation to the structure; placement of electrons features; and/or rotation mechanisms in one or more dimensions, and or indicators of the magnetic fields of the individual base units representing nuclear particles.

### STATEMENT ON FEDERAL FUNDING

No federal funding of research was used in connection with the present invention.

### BACKGROUND OF THE INVENTION

### 1. Field of the Invention

The present invention relates generally to instructional aids, manipulatives, and displays used in teaching or using concepts relating to organic and inorganic chemistry, particle physics, and molecular bonding which occurs in relationship to the nucleus structure and the nucleus magnetic orientation plus those two as related to specific electron-shells, predictable bond-angles and magnetic orientation.

### 2. Description of Prior Art

Prior art for model and manipulatives of structures for chemistry set in education exist. These include chemistry sets, which focus on the complete atoms and the connections between the atoms (U.S. Pat. No. 4,325,698 A, U.S. Pat. No. 4,398,888 A, US 20020072045 A). However, these are not models or manipulatives for the nucleus itself, its magnetics, or those two together.

The use of magnetics for chemistry sets, toys, displays, and similar items has existed (U.S. Pat. No. 5,648,056, US20120122695, U.S. Pat. No. 7,390,477). There is lots of prior art about making them stronger, and for other particular uses, but none for specific use as the nucleus structure model or manipulative.

The use of frameworks for displaying that include the functionality of rotating exist (U.S. Pat. No. 4,919,383, U.S. Pat. No. 5,205,636, U.S. Pat. No. 6,018,899, U.S. Pat. No. 6,115,950). Many with special uses, but none for specific use as the nucleus, the magnetic orientation of the nucleus, as part of chemistry models or manipulatives.

The prior filing (15245326) related to magnetics added to chemistry sets for bonding angles. The present invention focuses more specifically to connect those magnetic attributes in the prior filing (15245326) to display the cause of them from the nucleus particle assembly. That invention focuses on better methods to display and manipulate magnetic attributes with electrons and bonds to create molecules for education. The present invention pushes the training towards the nucleus and its magnetics. In effect, the two inventions meet and share functionality at the magnetics attributes which derive and link downward, from the nucleus source, in the present invention, and work upward to the bonding with other molecules via electron shells and bond locations in the prior filing (15245326).

### SPECIFICATIONS

The primary object of the present invention is to provide integrated displays or manipulatives for chemistry education that help understand the structure and properties of the nucleus.

A primary object of the present invention is to provide integrated displays or manipulatives for chemistry education that help understand the magnetic orientation and/or strength generated by various configurations base-units representing particles that comprise the nucleus, including elements, isotopes, or nucleus-particle configuration

A primary object of the present invention is to provide integrated displays or manipulatives for chemistry education that help understand the orientation of the magnetic orientation of the nucleus and magnetic field movements by rotation.

A primary object of the present invention is to provide integrated displays or manipulatives for chemistry education that help understand the structure and orientation of the electrons and bonds in relationship to the magnetic orientation generated by the nucleus.

A primary object of the present invention is to provide integrated displays or manipulatives for chemistry education that help understand the structure and orientation of the electrons in relationship to the magnetic orientation of the nucleus.

A primary object of the present invention is to provide integrated displays and manipulatives for chemistry education that help to show how nucleus structure, its magnetics influence the electrons-shells and bonding locations and angles

Further objects of the invention will appear as the description proceeds.

The understanding of chemistry requires many formula and calculations. Yet, for many people, visual and manipulative tools help understanding better. To be able to see the relationship, or to use one's own efforts to make the connection either work or not work is powerful, especially for those not comfortable with formulas alone. Research shows that the path for learning can be visual, auditory, kinesthetic (manipulating), or abstract (formulas or spreadsheets). Much of learning is a crooked path using more than one method until complete understanding gets reached. Further, that understanding gets retained differently by different people; some remember concepts as visual, some as kinesthetic (manipulative), some as words, and some as spreadsheets and formulas. That makes alternatives with visual and kinesthetic functionality powerful and enduring.

Most of chemistry is taught using formulas. The present invention seeks to add novel visual and kinesthetic (manipulating) structures for education and understanding of chemistry and its concepts.

### PURPOSE

The present invention has an educational and design display or manipulative with the combination of the first two below functionality objects in claim 1, and in other claims for more than one of the further attribute and functionality presentation(s):

Nucleus Structure and Field Modeling and Manipulatives
Base units representing nucleus particles, including protons and neutrons, with attributes or marking to distinguish the different particles that connect in some fashion with their physical structure;
Magnetism functionality for the connection of the base units to allow their connection in various structures as guided by the laws of magnetism, especially into structures such as chains, single-rings, double-rings and to the surrounding environment;

Nucleus-to-Electron Shell Relationship Modeling and Manipulatives
A framework to hold a nucleus-unit, representing a nucleus, that has a defined magnetic orientation and presents that orientation via a visible structure, including but not limited to spindles, antennas, protrusions, or lighted features;
The rotation of that framework in one or more directions, one of which matches the magnetic orientation from the nucleus-unit; and/or
Electron(s) or bond(s) placement and separation-distances structures restricted by the features of the framework based upon magnetic field orientation

Much of the challenge for the understanding of chemistry flows from more than bond angles and strength. In fact, the bond angles themselves come from an understanding of a) electromagnetics, and b) the complete set of electron placements. Further, those electromagnetics and electron placements comes from the nature of the nucleus including electrodynamics. Bonds being open positions in the electron-shell from the atom's own electrons combined with the electrons of the neighboring molecule in the bond. It is that electromagnetism that drives, for the specific element, the choice of field placement for electrons. It is that electron placement for a particular element that creates the locations open for bonding. The bonds are the location in the field where the atom's own electrons have not already settled. Those bonding locations are then set with fixed angles. The path, speed, and strength of bonding gets impacted by both a) and b). Both a) and b) actually are precursors to the bond angle.

Further, both a) and b) have the nucleus structure as a precursor to them. The structure of the nucleus determines the strength and orientation of the magnetic field. As a result, the present invention creates a more complete view for understanding the combination of factors that create the various elements of the periodic chart.

### CONCLUSION

In many ways, the formulas of chemistry education cannot explain such relationships like the prior art of basic chemistry sets or like the present invention, an enhanced chemistry set focused on the neucleus features. The ability to move the bonds and atoms, represented by bases and connectors, see both electrons and magnetic features of those in combination, makes complex calculation of trigonometry real and practical. This invention takes this historical tool to another level with the additional features of existing electron placement, magnetic field orientation, and magnetic field strength in addition to the traditional bonding features.

The creation of manipulatives and models which includes multiple elements takes extra efforts, especially given the complex interaction of electrical charge, magnetic fields, magnetic orientation and differences in particles and bonds distances, and separation rules, but the objective of the present invention is that integration improves the understanding of students and users better. Further, the uses of a nucleus modeling or manipulative structure itself goes beyond any prior art for that educational tools for driven by set of attributes. The present invention modeling method for the logic and structure for nucleus particles with the created magnetic field replaces formulas and tables with ways in which a student better relates. The concepts of magnetic moment, Pauli exclusions, and potentially even spin do not need abstract understanding for a subset of students preferring visual and kinesthetic learning tools. The goal is that innovative extra work in the design and presentation creates better a teaching tool.

### BRIEF DESCRIPTION OF THE FIGURES

The figures show various views of the arrangement or structures of base-unit features, representing nucleus particles, magnetic orientation of the particles or the structure, and features for their display or manipulation.

FIGS. 1-10 show various embodiments of the nucleus particle display base-unit features in different configurations.

FIG. 1 is a side view for structure for 001-H Hydrogen Trillium isotope nucleus with one proton and two neutrons in a chain formation.

FIG. 2 is a top view for a structure for the most common 002-He Helium nucleus with two protons and two neutrons in a ring formation.

FIG. 3 is a side view for a structure for the most common 002-He Helium nucleus with two protons and two neutrons in a ring formation.

FIG. 4 is a 3D upper view for structure for the common 006-C Carbon nucleus with six protons and six neutrons as a single ring.

FIG. 5 is a 3D upper view for structure for the common 006-C Carbon nucleus with six protons and six neutrons as a connected-two-flat-ring structure.

FIG. 6 is a 3D upper view for structure for the common 004-B Boron nucleus with four protons and four neutrons as a single ring.

FIG. 7 is a top view for structure for 001-Hydrogne Trillium isotope nucleus with one proton and two neutrons.

FIG. 8 is a side view for structure for 008-O Oxygen nucleus with eight protons and eight neutrons organized as a double ring, where only four protons and four neutrons are visible in the side view.

FIG. 9 is a side view for structure for 008-O Oxygen nucleus with eight protons and eight neutrons organized as a double ring, where only four protons and four neutrons are visible in the side view.

FIG. 10 is a side view for structure for 007-N Nitrogen nucleus with seven protons and eight neutrons organized as a double ring, where only four protons and four neutrons are visible in the side view.

FIGS. 11-20 show various embodiments of the nucleus display base units in combination with the magnetic orientation display feature.

FIG. 11 is a top view for a structure for the most common 002-He Helium nucleus with two protons marked ‘P’ and two neutrons marked ‘N’ in a ring formation. An additional feature shows that the ring of magnets generate a magnetic orientation perpendicular to that magnetic ring of particles.

FIG. 12 is a 3D side view for a structure for the most common 002-He Helium nucleus with two protons and two neutrons in a ring formation. An additional feature shows that the ring of magnets generate a magnetic orientation perpendicular to that magnetic ring of particles.

FIG. 13 is a side view for a structure for the most common 001-H Hydrogen nucleus with one proton marked ‘P’ and zero neutrons in a single particle formation. An additional feature shows that the particle still generates a magnetic orientation.

FIG. 14 is a side view for a structure for the most common 001-H Hydrogen nucleus with one proton marked ‘P’ and zero neutrons in a single particle formation. An additional feature shows that the particle still generates a magnetic orientation.

FIG. 15 is a side view for a structure for the most common 008-O Oxygen nucleus with eight proton marked ‘P’ and eight neutrons marked ‘N’ for total eighteen particles in a double-ring formation such that neutrons separate each proton both along the ring and between the ring layers. An additional feature shows that the particle still generates a magnetic orientation.

FIG. 16 is a side view for a structure for a common 002-He Helium nucleus with two protons marked ‘P’ and two neutrons marked ‘N’ in a double ring formation. An additional feature has a features indicating the magnetic orientation and a display showing the magnetic strength based upon that orientation.

FIG. 17 is a 3D side view for a structure for the most common 002-He Helium nucleus with two protons and two neutrons in a ring formation. One additional feature shows that the ring of magnets generate a magnetic orientation perpendicular to that magnetic ring of particles. An additional feature shows the placement of electrons relative to that nucleus and its magnetic orientation indicator.

FIG. 18 is a 3D side view for a structure for the most common 002-He Helium nucleus with two protons and two neutrons in a ring formation. One additional feature shows that the ring of magnets generate a magnetic orientation perpendicular to that magnetic ring of particles. An additional feature is a rotating display to allow viewing element from various orientations.

FIG. 19 is a 3D side view for a structure for the most common 002-He Helium nucleus with two protons and two neutrons in a ring formation. One additional feature shows that the ring of magnets generate a magnetic orientation perpendicular to that magnetic ring of particles. An additional feature is a rotating display to allow viewing element from various orientations, and that display has been rotated.

FIG. 20 is a side view for a structure for the most common 006-C Carbon nucleus with six protons and six neutrons for total twelve particles in a double-ring formation such that neutrons separate each proton both along the ring and between the ring layers. An additional feature shows that the particle still generates a magnetic orientation.

FIGS. 21-27 show various embodiments of the nucleus display base units in combination with the magnetic strength, as well as electron and bond locations.

FIG. 21 is a side view with a Nucleus, as a magnetic ring, with its magnetic orientation, with both Electron Placement and Bonding Locations, and with an additional feature of a display that includes magnetic strength.

FIG. 22 is the electron and bond cube positions for elements in valence Shell 1, such as 006-C Carbon. The placements of either bonds or electrons go into a cube locations with either points (2201-2208) with two having the magnetic orientation (2203, 2006).

FIG. 23 is a side view for a structure for the most common 007-N Nitrogen nucleus with seven protons and eight neutrons for total fifteen particles in a double-ring formation. In order that neutrons separate each proton both along the ring and between the ring layers the configuration must have 2×7 alternating pattern in the pair of connected rings with an additional neutron alone at the crossover point so that protons do not meet. An additional feature shows that the particle still generates a magnetic orientation.

FIG. 24 is a side view with a 007-N Nitrogen nucleus, as represented as a magnetic ring, with its magnetic orientation, with both electron placement and bonding locations, and with an additional feature of a display that includes magnetic strength.

FIG. 25 is the electron and bond cube positions for elements in valence Shell 1, such as 006-C Carbon after taking into account the different strengths of the magnetic field generated from the nucleus.

FIG. 26 is a side view with a Nucleus, as a magnetic ring, with its magnetic orientation, with both Electron Placement and Bonding Locations, and with an additional feature of a display that includes magnetic strength.

FIG. 27 is a 3D side view for a structure for the most common 003-Be Beryllium nucleus with three protons and three neutrons in a ring formation. One additional feature shows that the ring of magnets generate a magnetic orientation perpendicular to that magnetic ring of particles. Another additional markings shows the magnetics of the individual particles which is not the same as the magnetics of the combined structure.

### DETAILED DESCRIPTION OF THE FIGURES

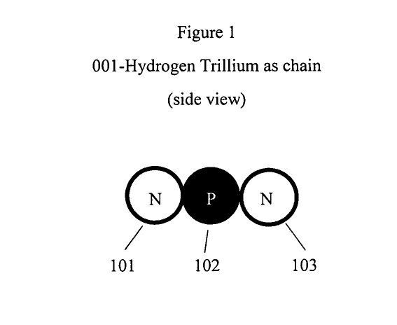

As shown in FIG. 1, one embodiment of the present inventions is the combination of base-units (101, 102, 103) as a chain, as in the example embodiment of a 001-H Hydrogen trillium isotope nucleus. It includes one black base unit marked ‘P’ representing a proton (102) in two white base units marked ‘N’ (101, 103) of interior representing neutrons.

FIG. 1 (side view) 001-Hydrogen Trillium

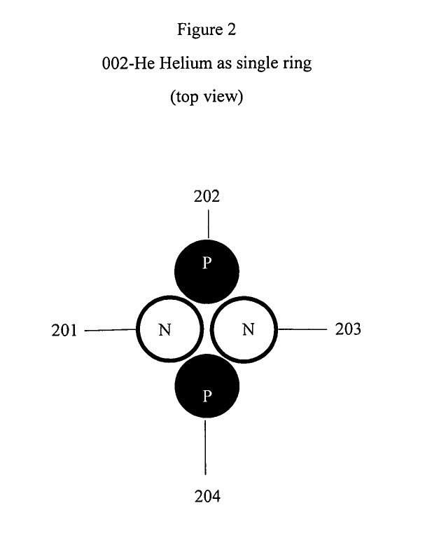

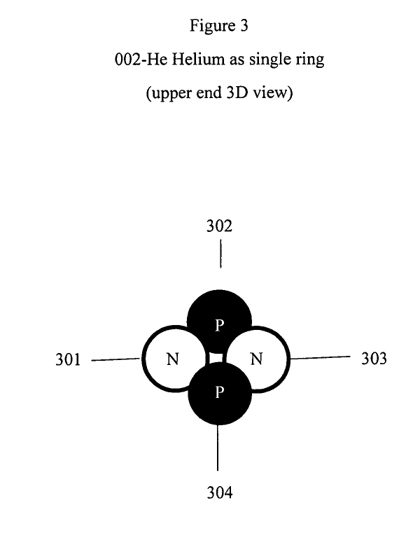

As shown in FIG. 2 as a top view and FIG. 3 as a 3D end view from slightly above, one embodiment of the present invention for a nucleus representation for 002-He Helium is the combination of base-units (201, 202, 203, 204) as a chain-ring. It includes two black base units marked ‘P’ representing protons (202, 204) in two white base units marked ‘P’ representing neutrons (201, 203).

FIG. 2 (top view) 002-He Helium

FIG. 3 (upper end 3D view) 002-He Helium

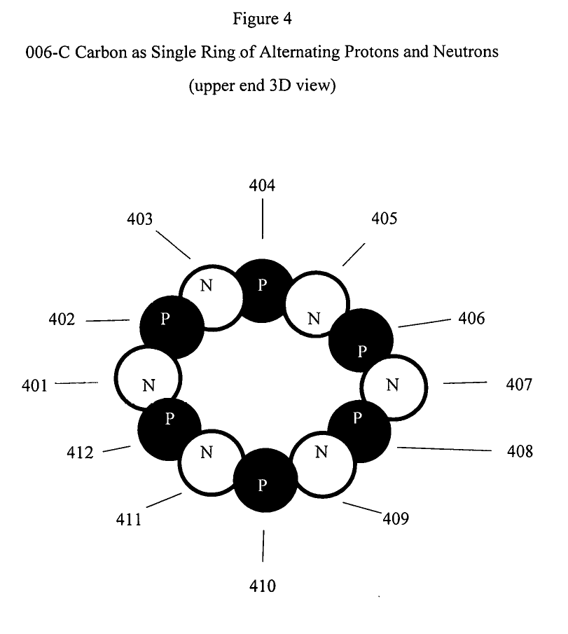

As shown in FIG. 4 as a 3D end view from slightly above, the nucleus representation is the combination of base-units (1-12) as a single chain-ring, as in one form of 006-C Carbon. It includes six black base units marked ‘P’ representing proton(s) (402, 404, 406, 408, 410, 412) in two base units of white interior representing neutrons marked ‘N’ (401, 403, 405, 407, 409, 411).

FIG. 4 (upper end 3D view) 006-C Carbon

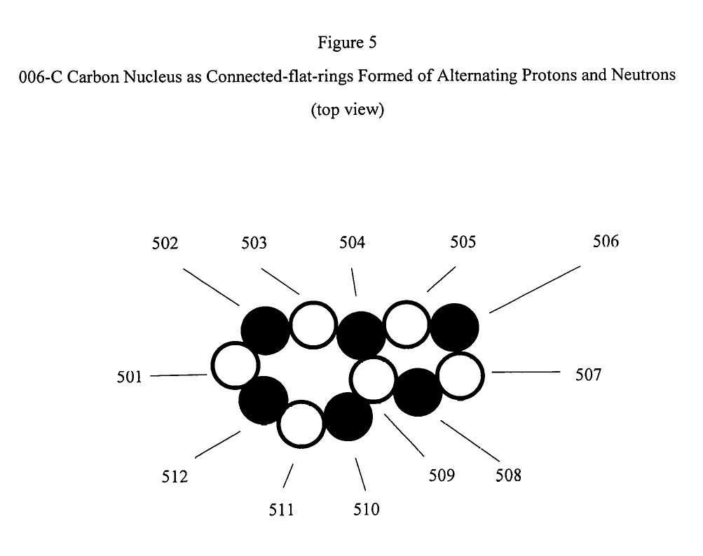

As shown in FIG. 5 as a top view, another embodiment of the present invention is a nucleus representation of base-units (501-512) as a paired chain-ring, as in one manipulative structure of the 006-C Carbon nucleus. It includes six black base units marked ‘P’ representing protons (502, 504, 506, 508, 510, 512) in two base units of white interior representing neutrons (501, 503, 505, 507, 509, 511). Each proton separated by a neutron in this embodiment.

FIG. 5 (top view) 006-Carbon Double Ring

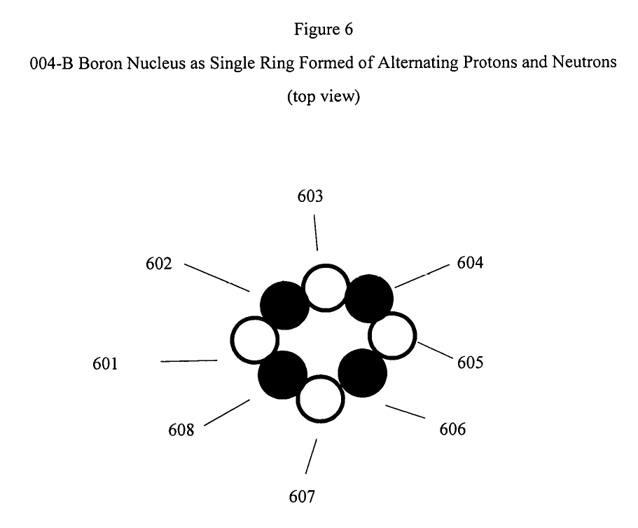

As shown in FIG. 6 as a top view from slightly above, another embodiment of the present invention has the combination of base-units (601-616) as a 2-tier chain-ring, as part of the display or manipulative of 008-O Oxygen. The full structure includes eight black base units representing proton(s) (602, 604, 606, 608, 610, 612, 614, 616) in eight base units of white interior representing neutrons (601, 603, 605, 607, 609, 611, 613, 615) again each proton separated by a neutron even when in a double ring structure.

From the top only units (601-608) are visible in FIG. 6.

FIG. 6 (top view) 008-O Oxygen Double Ring

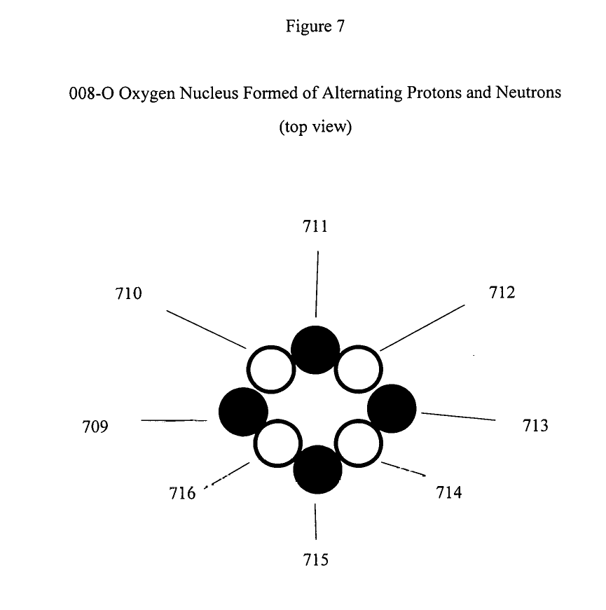

In FIG. 7, the bottom view shows that the reverse pattern of remaining base-units (709-716) such that the lower, 2^{nd} layer has protons that touch neutrons of layer 1, and neutrons that touch Layer 1 protons.

FIG. 7 (bottom view) 008-O Oxygen Double Ring

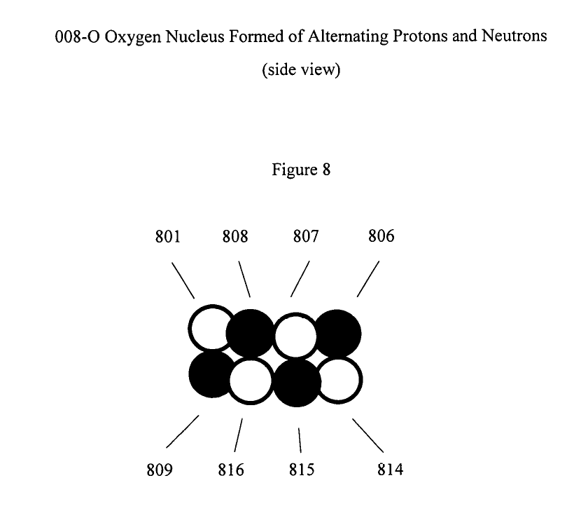

In FIG. 8, the side view of 008-O Oxygen shows that the separation pattern works from layer to layer. The four visible base units for neutrons (801, 807, 814, 816) separate the four visible base units for protons (806, 808, 809, 815)

FIG. 8 (side view) 008-O Oxygen Double Ring

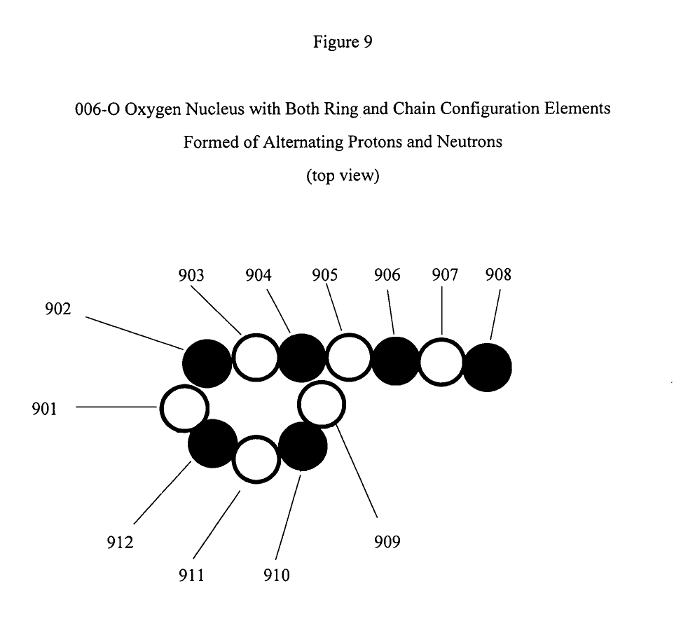

As shown in FIG. 9, another embodiment of the present invention would have a combination of base-units (1-12). It includes a ring of base units (901, 902, 903, 904, 909, 910, 911, 912) plus a chain (905, 906, 907, 908) in combination. This configuration follows the neutron-separation-of-protons logic.

FIG. 9 (top view) Combination Ring and Chain

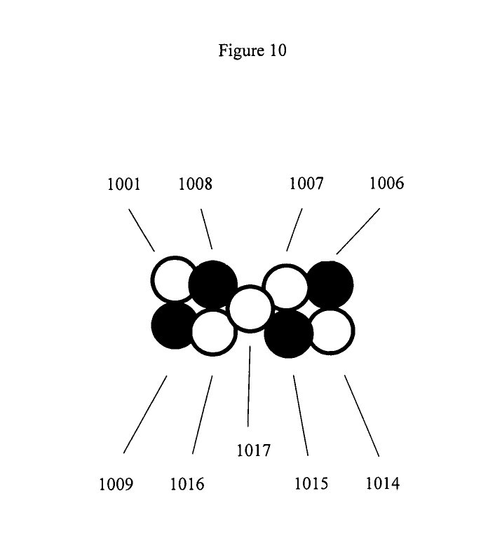

As shown in FIG. 10, another embodiment might has the same as FIG. 8, plus an additional neutron, not violating the separation guide, but instead the rule is ‘at least one’ allowing for more than one neutron in the separation position. In this case, a 007-N Nitrogen nucleus has an odd number of protons. As a result, the most common structure would be a double ring of 7×2 wide, alternating proton-neutron, but because the last row would have proton meeting proton, an extra neutron as a single layer, not 2-across creates the stable nucleus structure for 007-N Nitrogen. The visible base-units for protons (1006, 1008, 1009, 1015) have base-units for neutrons (1001, 1007, 1014, 1016, 1017) which create separation of base-units representing the protons at 1008 and 1015, by more than one neutron (1007, 1016, 1017).

FIG. 10 (side view)

Claim 1 includes both base unit(s) and magnetic orientation indicator(s) in combination for modeling, display or manipulative. The connections between the base units and magnetic orientation indicator are left to common sense, such as string, wire, sticks or adhesive although a specific advantageous method, magnetics, will get added in claim 2.

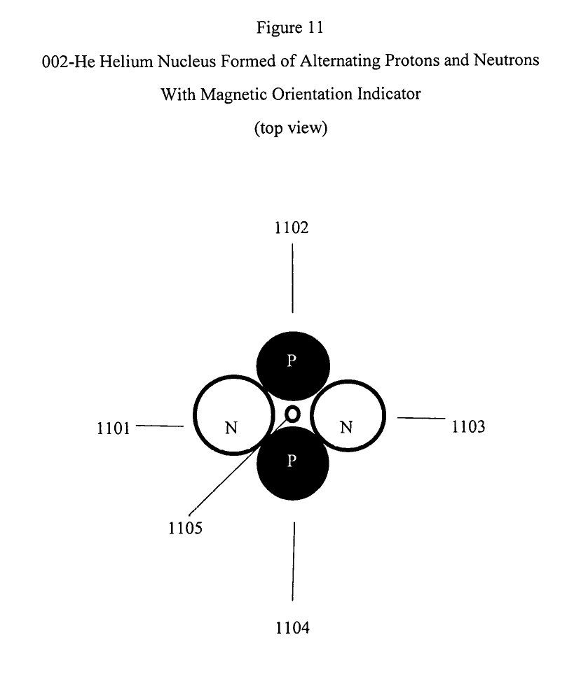

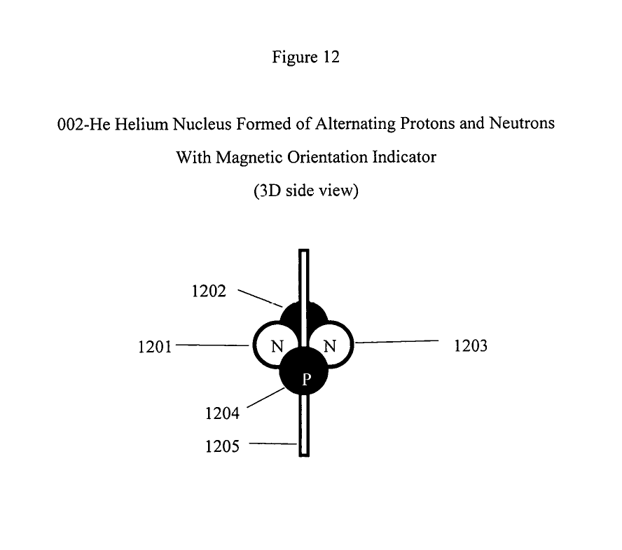

One embodiment of the current invention claim 1 would have base-units for 002-He Helium together with the magnetic orientation indicator. As shown in FIG. 11 as a top view and FIG. 12 as a side 3D view, the combination of base-units (1101,1102,1103,1104) as a chain-ring, as an embodiment for a 002-He Helium atom. It includes two black base units representing proton(s) marked ‘P’ (1102,1104) in two base units of white interior representing neutrons marked ‘N’ with the addition of a magnetic orientation indicator (5) of the combination. Because of the nature of the four base-units representing particles, the overall magnetic indicator (5) runs through the center and perpendicular to the ring-set.

FIG. 11 (top view) 002-Helium

FIG. 12 (side 3D view) 002-Helium

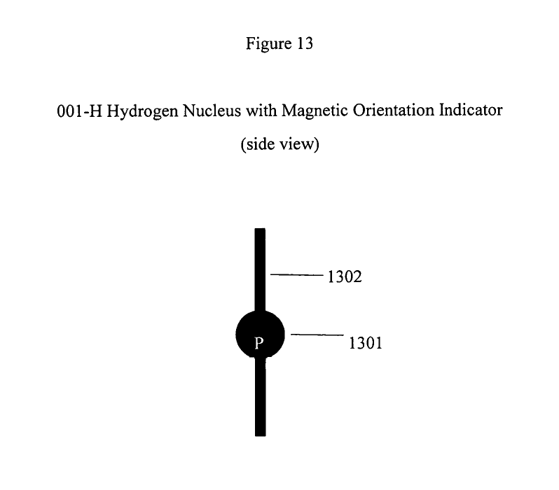

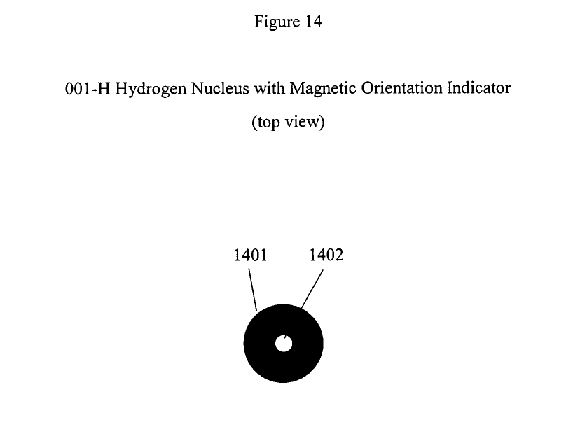

Another embodiment of the current invention claim 1 would have base-unit for 001-H Hydrogen together with the magnetic orientation indicator. As shown in FIG. 13 as a side view and FIG. 14 as a top view, the display or manipulative is the combination of base-units (1) alone, as on embodiment for a 001-H Hydrogen. It includes one black base units representing the proton (1) with the addition of a magnetic orientation object (2) of the combination.

FIG. 13 (side view) 001-Hydrogen

FIG. 14 (top view) 001-Hydrogen

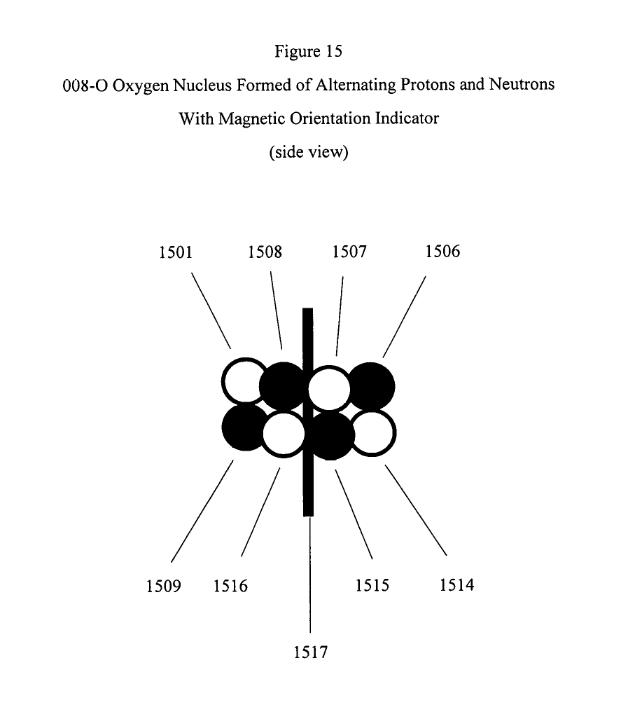

Another embodiment of the current invention claim 1 would have base-unit for 008-O Oxygen together with the magnetic orientation indicator. As shown in FIG. 15 as a top view and FIG. 4 as a 3D end view as a 3D end view from slightly above, the creation of a nucleus representation for training requires the combination of base-units (1501,1502,1503,1504) as a chain-ring, as on embodiment for a 002-He Helium atom. It includes two black base units representing proton(s) (1502,1504) in two base units of white interior representing neutrons with the addition of a magnetic orientation object (5) of the combination.

FIG. 15 (side view)

### FIGURES FOR ADDITIONAL CLAIMS

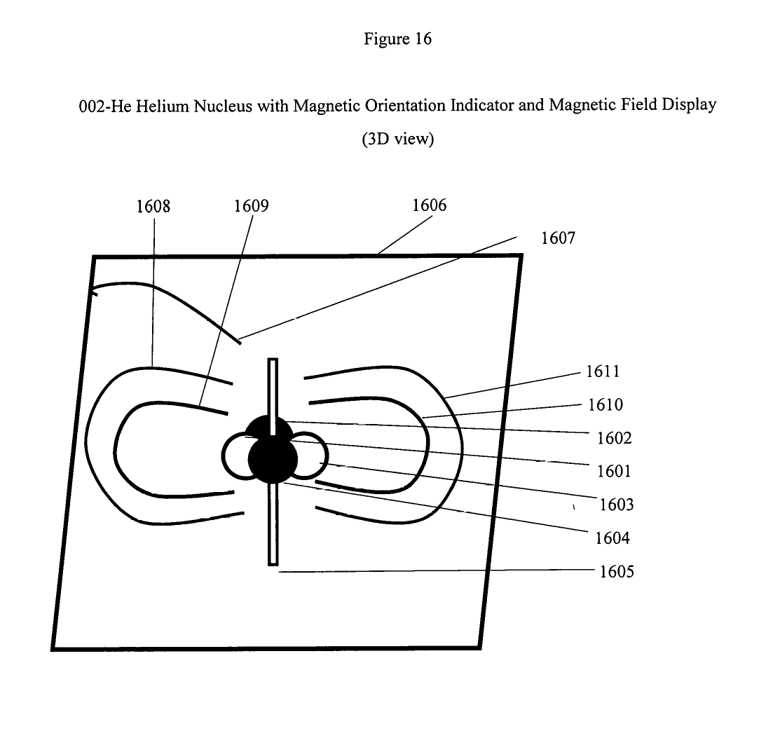

One embodiment of the present invention in claim 3 shows the base-units in a structure and magnetic orientation as in claim 1 plus a presentation of magnetic field strength. As shown in FIG. 16, the combination of base-units (1601, 1602, 1603, 1604) as a chain-ring, as on embodiment for a 002-He Helium nucleus. It includes two black base units representing proton(s) (1602,1604) in two base units of white interior representing neutrons with the addition of a magnetic orientation object (5) plus a display mechanism (6) presenting a 2D presentation of the magnetic field strength (1607,1608,1609,1610,1611).

FIG. 16 (side view) 002-Helium with display of magnetic field

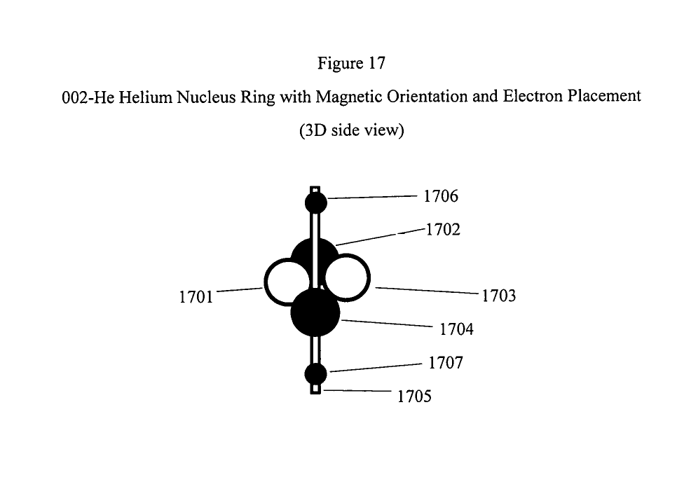

One embodiment of the present invention claim 3 shows the base-units in a structure and magnetic orientation as in claim 1 plus a presentation of electron(s) in an electron-shell. As shown in FIG. 17, the combination of base-units (1701, 1702, 1703, 1704) as a chain-ring, as on embodiment for a 002-He Helium nucleus. It includes two black base units representing proton(s) (1702,1704) in two base units of white interior representing neutrons with the addition of a magnetic orientation object (5) plus a display mechanism (1706, 1707) presenting the location, relative distance and/or shape of electrons in an electron shell.

FIG. 17 (side view) 002-Helium with display of electron field

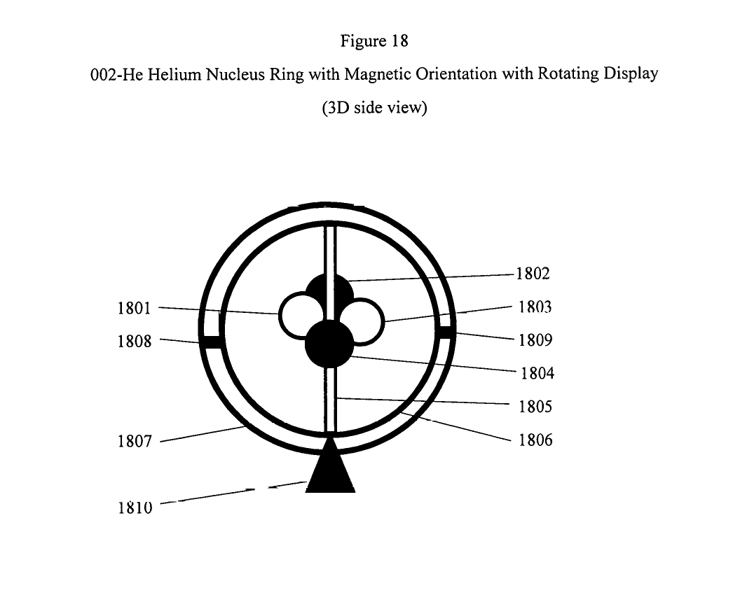

As shown in FIG. 18, the combination of base-units (1801,1802,1803,1804) as a chain-ring, as in a 002-He Helium with a magnetic orientation indicator sits within a rotating structure on a display base. It includes two black base units representing proton(s) (1802,1804) in two base units of white interior representing neutrons with the addition of a magnetic orientation with rotation mechanism(s) (1808,1809) on rotation framework(s) (1806,1807) on a display stand (1810).

FIG. 18 (side view)

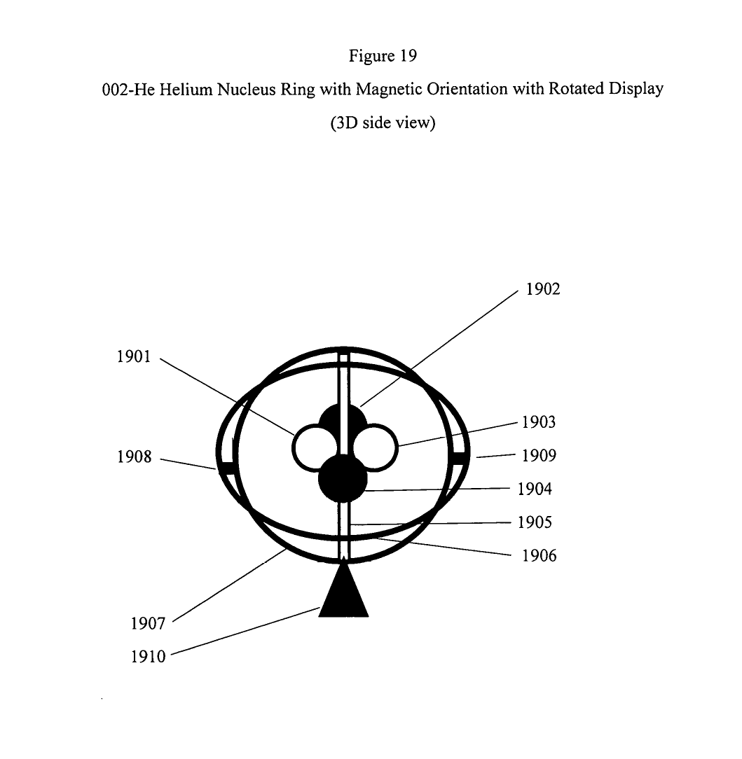

As shown in FIG. 19, the items from FIG. 18 are shows where the rotation axis (1908, 1909) has operated. The larger structure is in the same place, but the inner base-units have tilted upward on the (1908, 1909) axis in this embodiment.

FIG. 19 (upper end 3D view)

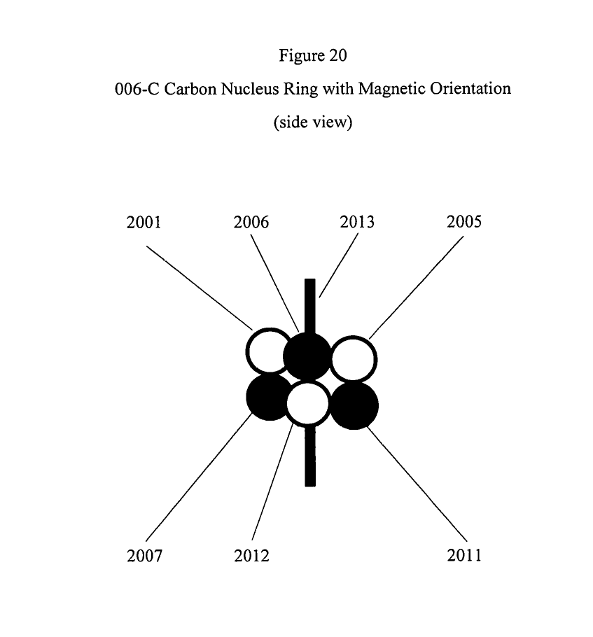

In one embodiment of the present invention, multiple features get combined. The display or manipulative shown in FIGS. 20-25 show the comparison by manipulation of electrons and bonds between a 006-C Carbon at Angles (2002,2003,2004) with the electrons and bond angles for 007-N Nitrogen (2007,2008,2009). The total presentation includes for 006-C Carbon the nucleus (1) in ring-structure with display-units in the north-south magnetic positions as a black, sphere for an electron (18) and a white, box for the bond location (20) and in the non-magnetic North-South positions round, black display-units for electrons (2002,2003,2004) and box, black bond angles locations (2005,2006,2007) with a magnetic orientation North-South indicator (2008) and connectors shown as lines (2009), as black box in this embodiment in a cube placement which also is two offset a tetrahedron of electrons, and a tetrahedron of bond locations by physical connections (2009,2010,2011) on a display mechanism (2022) showing magnetic fields (2023); plus for 007-N Nitrogen the nucleus (1) ring-structure with display-units in the north-south magnetic positions as a black, sphere for two electrons (2019,2021) and in the non-magnetic North-South positions round, white display-units for electrons (2012,2013,2014) and box, white bond angles locations (2005,2006,2007) with a magnetic orientation North-South indicator (8), as black box in this embodiment in a cube scrunched at the north-south position placement which also is two offset a tetrahedron of electrons, and a tetrahedron of bond locations by physical connections (2015,2016,2017).

In FIG. 20, the nucleus structure (1) of the type 006-C Carbon, as a ring structure, has base-units representing protons (2002,2004,2006,2008,2010,2012) and base-units representing neutrons (2001,2003,2005,2007,2009,2011) along with magnetic orientation indicator (2013) oriented perpendicular to the double ring structure. For this view, only some of the particle features are visible (2001, 2005, 2006, 2007, 2011, 2012) along with the magnetic orientation feature (2013).

FIG. 20 006-Carbon Ring

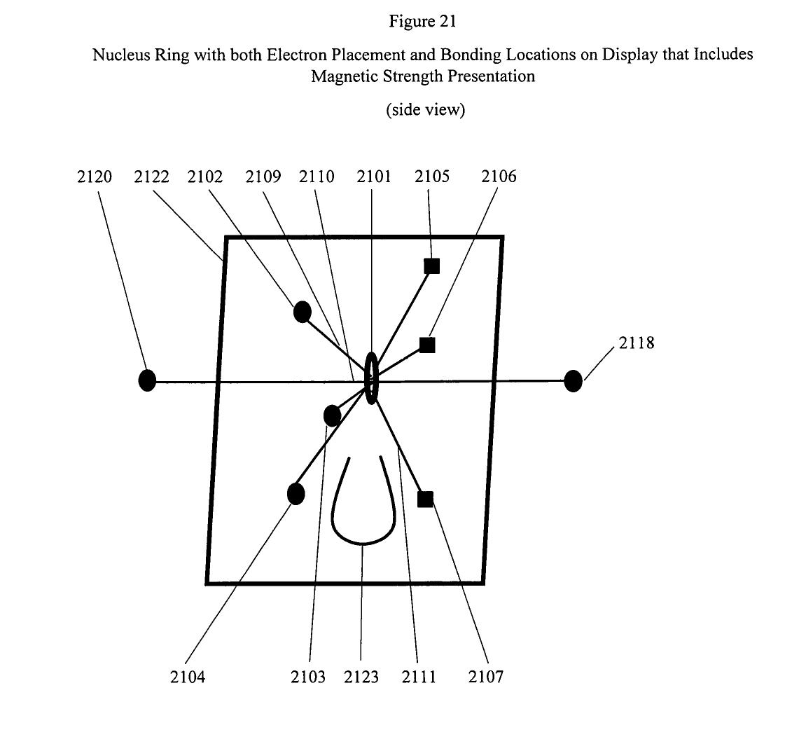

FIG. 21 shows just the 006-C Carbon components including the nucleus (1) in ring-structure with display-units in the north-south magnetic positions as a black, sphere for an electron (2118) and a black box for the bond location (2120) and in the non-magnetic North-South positions round, black display-units for electrons (2102,2103,2104) and box, black bond angles locations (2105,2106,2107) with a magnetic orientation North-South indicator (2108) and connectors shown as lines (2109), as black box in this embodiment in a cube placement which also is two offset a tetrahedron of electrons, and a tetrahedron of bond locations by physical connections (2109,2110,2111) on a display (2122) that includes a magnetic strength indicator (2123).

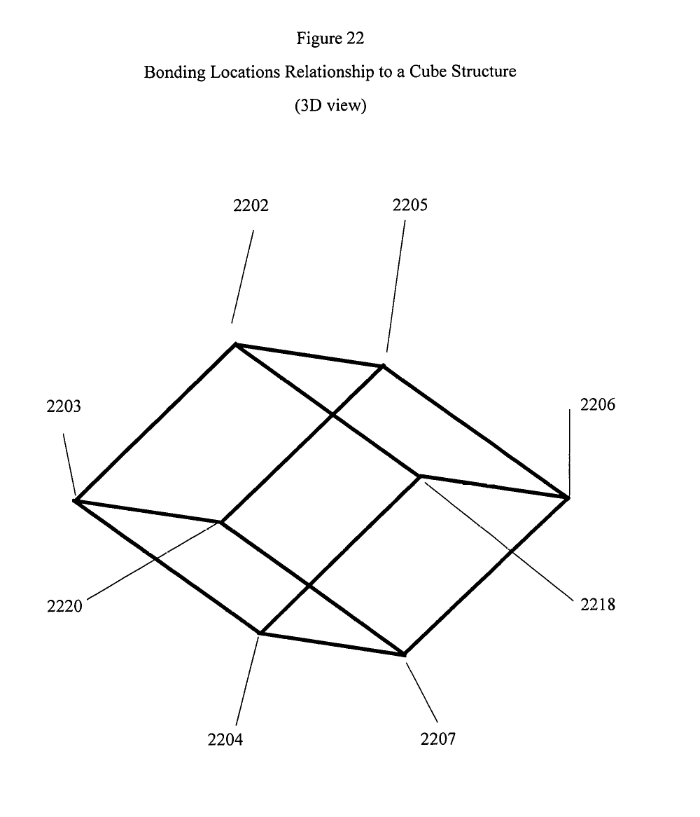

FIG. 22 shows just the Shell 2 atoms, such as 006-C Carbon, items related to the electron and bond cube positioning. The placements of either bonds or electrons go into a cube with either points (2201-2208) with two having the magnetic orientation (2203, 2006).

FIG. 22 006-C Carbon Ring Nucleus

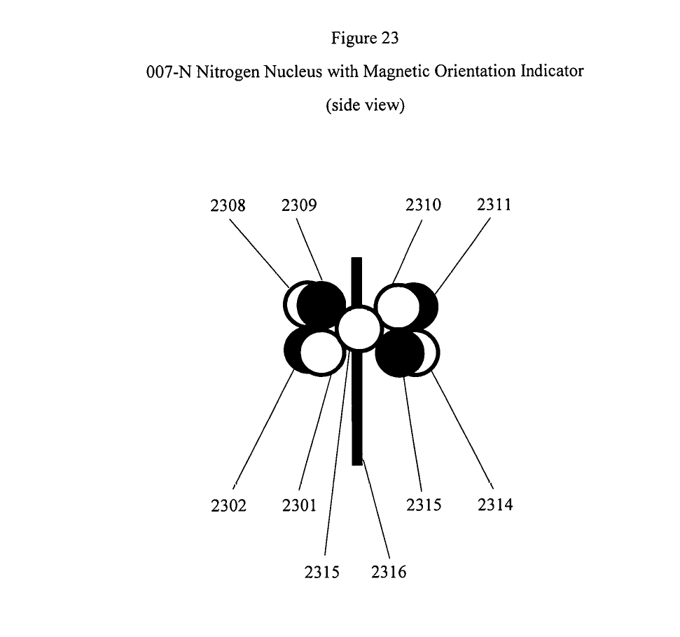

As shown in FIG. 23 as a top view the combination of base-units (1-16) as a 2-tier chain-ring, as in one form of 007-N Nitrogen. It includes seven black base units representing proton(s) (2302, 2304, 2306, 2308, 2310, 2312, 2314) in eight base units of white interior representing neutrons (2301, 2303, 2305, 2307, 2309, 2311, 2313, 2315) again each proton separated by a neutron with a magnetic orientation indicator (2316). Of those, only

FIG. 23 007-Nitrogen Ring Nucleus

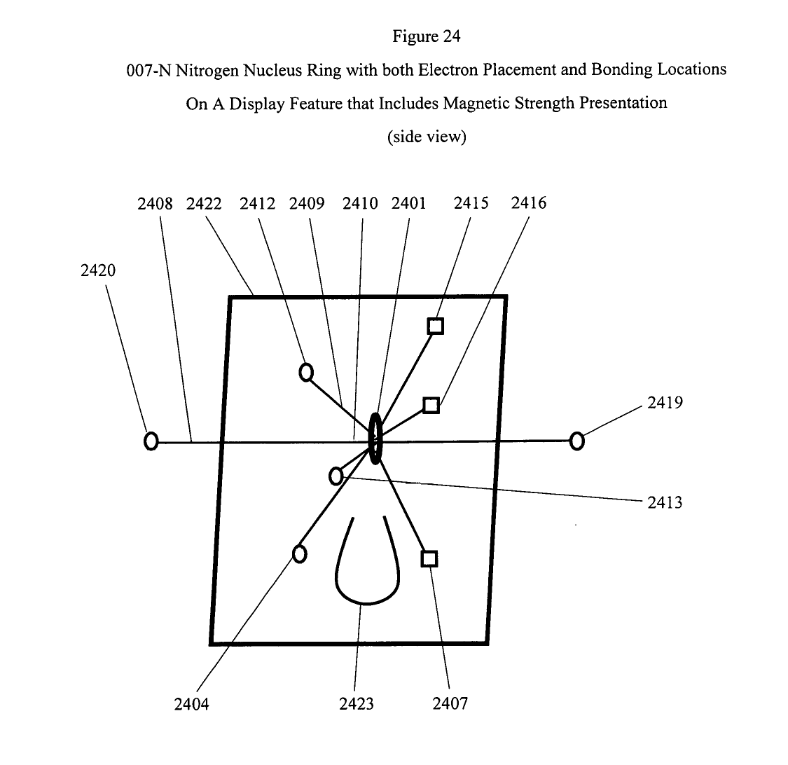

FIG. 24 shows just the 007-N Nitrogen including the nucleus (2401), as a ring structure, as one element of the drawing as compared to all the details like in FIG. 1-10, with display-units in the north-south magnetic positions as a white spheres for electron (2419,2421) and in the non-magnetic North-South positions round, black display-units spheres for electrons (2412,2413,2414) and black boxes as bond angles locations (2415,2416,2417) with a magnetic orientation North-South indicator (2408), as black box in this embodiment in a cube placement which also is two offset a tetrahedron of electrons, and a tetrahedron of bond locations by physical connections (2409,2410) on a display (2422) that includes a magnetic strength indicator (2423).

FIG. 24

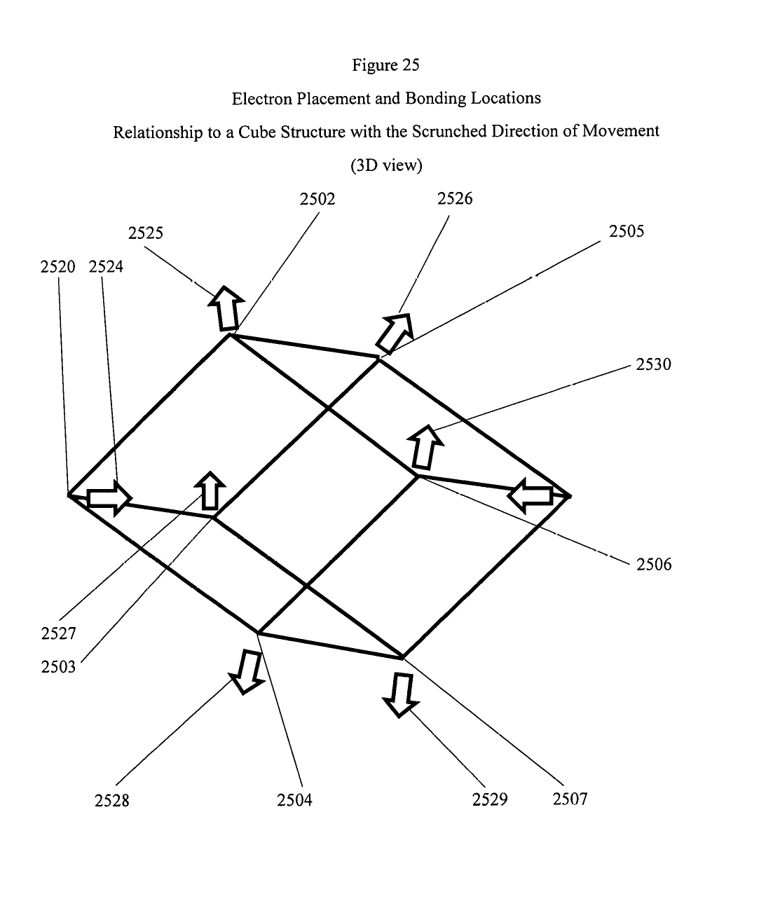

FIG. 25 shows one embodiment of the present invention, the structure to hold the electrons would be a scrunched cube anchored at north and south based upon the magnetic field indicator (2508) coming from the nucleus structure (2501) where the 007-N Nitrogen items related to the electron and bond positioning where the north-south in scrunched cube with arrow (2524,2525,2526,2527,2528,2529) indicating the direction of repositioning in the comparison of 006-C Carbon and 007-Nitrogen with the North-South locations moving inward (2518,2520) and the others (2502,2503,2504,2505,2506,2507) pushing outward.

FIG. 25

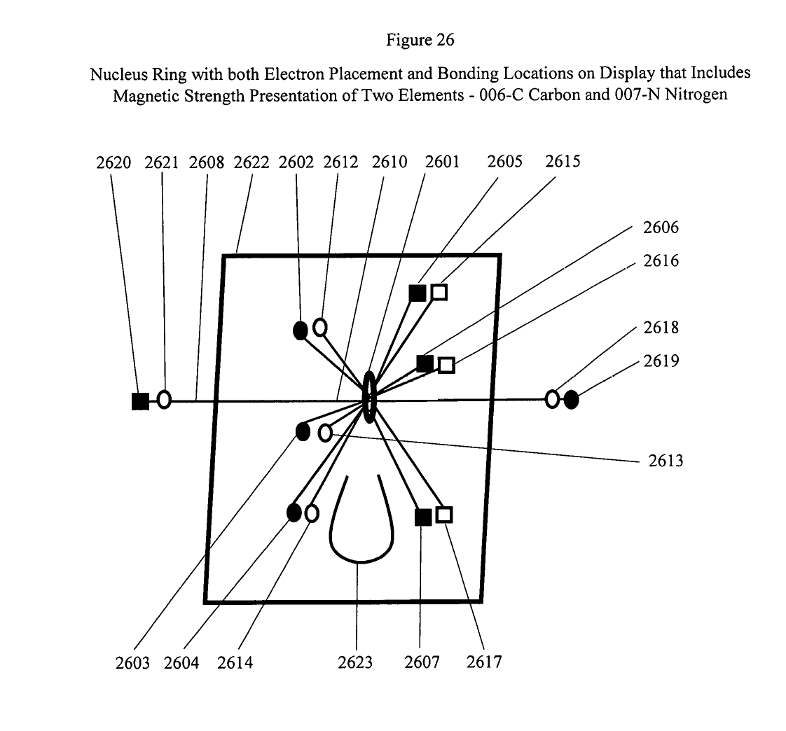

FIG. 26 shows both the 006-C Carbon and 007-N Nitrogen.

In claim 2, the use of magnetics for connectors make the devise manipulative, and as such were added as a separate claim. The user can connect and disconnect magnetics easily to try to build nuclear structures that handle periodic table elements and isotopes of those and generate certain magnetics strength and orientation understanding easier. Standard methods of connections occur by wire, string, or adhesive lack the manipulative features and seem part of the common sense implementation of claim 1. The use of magnetics for the connections added manipulative features as useful and novel for the purpose of the present invention and so were stated as an added claim built upon claim 1.

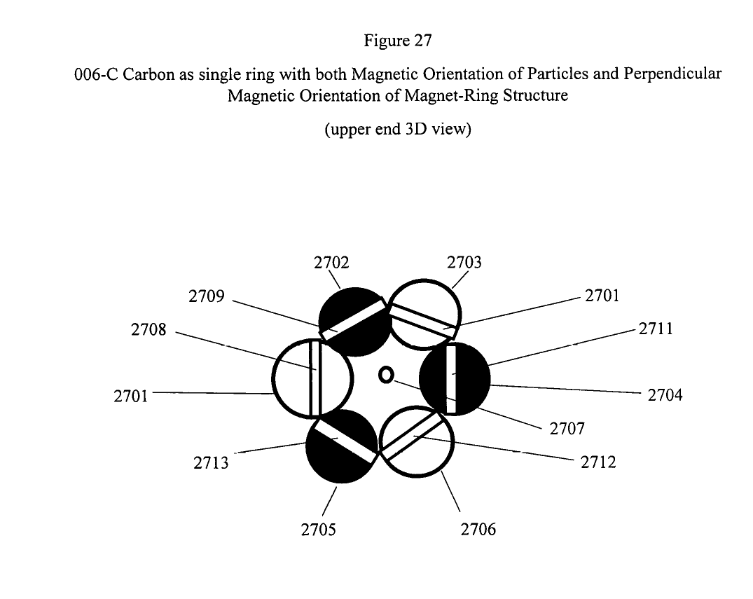

Further claim #2 in one embodiment of the present inventions includes use of magnetized base-units for the functionality of connection which allows for manipulation by the student-learner. In FIG. 27 as a top view, one embodiment of the present invention utilizes the combination of base-units (2701,2702,2703,2704,2705,2706) as a chain-ring, as on embodiment for a atom with a marker for the magnetic orientation indicator (7) of the nucleus-set as a whole along with magnetic orientation as a manipulative functionality (2708,2709,2710,2711,2712,2713) of the individual base-units as structured. The magnetics of claim 2 add manipulative functions, and may not actually be visible indicators on the base-units themselves.

In the FIG. 27, additional markings shows that the magnetics of the individual particles are not the same as the magnetics of the combined structure.

FIG. 27 (top view) 006-C Carbon

I claim:

1. a nucleus-structure chemistry set, being manipulative or display, that includes base object or objects differentiated by color, size, or marking, such base objects representing protons and neutrons, where such base object or objects connect in a manner as to demonstrate required proton-neutron-proton separation of protons by at least one neutron in any of chain, ring, double-ring, or combination structure together with structure or structures or attachment or attachments to indicate the orientation and/or strength of magnetic fields relative to said base nucleus combination.

2. a nucleus-structure chemistry set as in claim 1 where the physical connections between the base objects occurs by magnetics.

3. a nucleus-structure chemistry set as in claim 1 with at least one of the following: a display or manipulation structure that rotates on one or more dimensions; a framework or structure to indicate at least one of electron location or bond location associated with any of a number of configurations; or a display of at least one electromagnetic field strength.
